(19) United States
(12) Patent Application Publication
(10) Pub. No.: US 2023/0215076 A1
(43) Pub. Date: Jul. 6, 2023

(54) IMAGE FRAME DISPLAY METHOD, APPARATUS, DEVICE, STORAGE MEDIUM, AND PROGRAM PRODUCT

(71) Applicant: Tencent Technology (Shenzhen ) Compay Limited, Shenzhen (CN)

(72) Inventor: Xinda ZHAO, Shenzhen (CN)

(21) Appl. No.: 18/121,330

(22) Filed: Mar. 14, 2023

Related U.S. Application Data
(63) Continuation of application No. PCT/CN2022/092495, filed on May 12, 2022.

(30) Foreign Application Priority Data
Jun. 7, 2021 (CN) 202110631176.7

(51) Int. Cl. G06T 15/00; A63F 13/35

(52) U.S. Cl. CPC G06T 15/005; A63F 13/35; A63F 2300/53; A63F 2300/66

(57) ABSTRACT

Embodiments of this application disclose an image frame display method performed by a computer device. The method includes: receiving a first rendering instruction transmitted by a server, and rendering at least one first image element based on the first rendering instruction; receiving at least one second image element transmitted by the server, the at least one second image element being rendered by the server; receiving an interactive instruction transmitted by the server; and displaying an image frame based on the at least one first image element, the at least one second image element, and the interactive instruction.

### CROSS-REFERENCE TO RELATED APPLICATIONS

This application is a continuation application of PCT Patent Application No. PCT/CN2022/092495, entitled “IMAGE FRAME DISPLAY METHOD, APPARATUS, DEVICE, STORAGE MEDIUM, AND PROGRAM PRODUCT” filed on May 12, 2022, which claims priority to Chinese Patent Application No. 202110631176.7, filed with the China National Intellectual Property Administration on Jun. 7, 2021 and entitled “IMAGE FRAME DISPLAY METHOD, APPARATUS, DEVICE, STORAGE MEDIUM, AND PROGRAM PRODUCT”, all of which is incorporated herein by reference in its entirety.

### FIELD OF THE TECHNOLOGY

This application relates to the field of cloud technologies, and in particular, to an image frame display method, apparatus, and device, a storage medium, and a program product.

### BACKGROUND OF THE DISCLOSURE

Currently, in a cloud game scenario, a game picture is generally rendered through video streaming on a server side.

In related art, for each graphic element in a to-be-rendered virtual scene picture, a server executes rendering of each graphic element based on a rendering library of the server by calling a rendering instruction, encodes and compresses the rendered image, and transmits the encoded and compressed image to a client through a network. Then, the client decompresses received compressed image data, and finally displays the decompressed image on the client.

### SUMMARY

Embodiments of this application provide an image frame display method, apparatus, and device, a storage medium, and a program product, to transfer part of image element rendering work from a server to a terminal, thereby reducing image quality loss caused by lossy compression performed on the image by the server, and enhancing the quality of the image displayed on the terminal. The following technical solutions are used.

According to an aspect, an embodiment of this application provides an image frame display method. The method is executed by a computer device and includes:
receiving a first rendering instruction transmitted by a server, the first rendering instruction being used for instructing to render at least one first image element;
rendering the at least one first image element based on the first rendering instruction;
receiving image data transmitted by the server, the image data including at least one second image element rendered by the server; and
displaying an image frame based on the at least one first image element and the at least one second image element.

According to another aspect, an embodiment of this application provides an image frame display method. The method is executed by a server and includes:
transmitting a first rendering instruction to a terminal, the first rendering instruction being used for instructing to render at least one first image element;
calling a second rendering instruction to render at least one second image element;
transmitting image data including the second image element to the terminal; and
transmitting an interactive instruction to the terminal, so as to cause the terminal to display an image frame based on the at least one first image element, the at least one second image element, and the interactive instruction, the interactive instruction being used for indicating a display mode of the at least one first image element and the at least one second image element.

According to another aspect, an embodiment of this application provides an image frame display apparatus. The apparatus includes:
an instruction receiving module, configured to receive a first rendering instruction transmitted by a server, the first rendering instruction being used for instructing to render at least one first image element;
a first rendering module, configured to render the at least one first image element based on the first rendering instruction;
a data receiving module, configured to receive image data transmitted by the server, the image data including at least one second image element rendered by the server; and
a frame display module, configured to display the image frame based on the at least one first image element and the at least one second image element.

In a possible implementation, the interaction module includes:
a first interaction submodule, configured to receive a first interactive instruction that corresponds to the first image element and is transmitted by the server; and
a second interaction submodule, configured to receive a second interactive instruction that corresponds to the second image element and is transmitted by the server.

In a possible implementation, the frame display module includes:
a mode determining submodule, configured to determine the display mode of the first image element and the second image element based on first interaction flag information in the first interactive instruction and second interaction flag information in the second interactive instruction, where the first interaction flag information is used for indicating the display mode of the first image element, and the second interaction flag information is used for indicating the display mode of the second image element; and
a frame display submodule, configured to display at least one first image element and at least one second image element according to the display mode of the first image element and the second image element, so as to display the image frame.

In a possible implementation, in response to the display mode being synchronous display, the first interactive instruction includes a first interaction parameter, the second interactive instruction includes a second interaction parameter, and the first interaction parameter and the second interaction parameter include synchronization time indication information of the first image element and the second image element, respectively; and
the frame display submodule includes:
   a synchronous display unit, configured to synchronously display image elements among the at least one first image element and the at least one second image element that match the synchronization time indication information, so as to display the image frame.

In a possible implementation, in response to the display mode being transparency synthesis display, the first interactive instruction includes a first interaction parameter, the second interactive instruction includes a second interaction parameter, and the first interaction parameter and the second interaction parameter include transparency information of the first image element and the second image element, respectively; and
the frame display submodule includes:
   a transparency determining unit, configured to determine transparency of the at least one first image element and the at least one second image element based on the transparency information of the at least one first image element and the at least one second image element; and
   a synthesis display unit, configured to perform transparency synthesis display on the at least one first image element and the at least one second image element based on the transparency of the at least one first image element and the at least one second image element, so as to display the image frame.

In a possible implementation, in response to the display mode being separate display, the frame display submodule includes:

a separate display unit, configured to separately display the at least one first image element and the at least one second image element, so as to display the image frame.

In a possible implementation, the first rendering module includes:
a function obtaining submodule, configured to obtain a rendering function name included in the first rendering instruction, and related parameters used during rendering the at least one first image element;
a first rendering submodule, configured to call, based on the rendering function name, a function interface corresponding to the rendering function name, so as to render the at least one first image element through the function interface and the related parameters.

In a possible implementation, in response to the image frame being a virtual scene picture, the first image element includes at least one of an icon, a graphic button of a virtual control, and a graphic including text content, superimposed on the virtual scene picture; and the second image element includes an image used for displaying the virtual scene in the virtual scene picture.

According to another aspect, an embodiment of this application provides an image frame display apparatus. The apparatus includes:
an instruction transmission module, configured to transmit a first rendering instruction to a terminal, the first rendering instruction being used for instructing to render at least one first image element;
a second rendering module, configured to call a second rendering instruction to render at least one second image element;
a data transmission module, configured to transmit image data including the second image element to the terminal; and
an interactive transmission module, configured to transmit an interactive instruction to the terminal, so as to cause the terminal to display an image frame based on the at least one first image element, the at least one second image element, and the interactive instruction, the interactive instruction being used for indicating a display mode of the at least one first image element and the at least one second image element.

In a possible implementation, the instruction transmission module includes:

an instruction transmission submodule, configured to transmit, to the terminal by a remote procedure call (RPC), a rendering function name of the first rendering instruction and related parameters used during rendering the at least one first image element.

In a possible implementation, the apparatus further includes:
a first element determining module, configured to, before the first rendering instruction is transmitted to the terminal, determine a to-be-rendered image element as the first image element in response to a specified parameter of the to-be-rendered image element satisfying a terminal rendering condition; and
a second element determining module, configured to determine the to-be-rendered image element as the second image element in response to the specified parameter of the to-be-rendered image element not satisfying the terminal rendering condition,
where the specified parameter includes at least one of image complexity and a display quality requirement.

According to another aspect, an embodiment of this application provides a computer device, including a processor and a memory, the memory storing at least one computer instruction, and the at least one computer instruction being loadable and executable by the processor to implement the image frame display method according to the foregoing aspects.

According to another aspect, an embodiment of this application provides a computer-readable storage medium, where the computer-readable storage medium stores at least one instruction, at least one program, and a code set or an instruction set, and the at least one instruction, the at least one program, and the code set, or the instruction set is loadable and executable by the processor to implement the image frame display method according to the foregoing aspects.

According to an aspect of this application, provided is a computer program product or a computer program, where the computer program product or the computer program includes a computer instruction, and the computer instruction is stored in a computer-readable storage medium. A processor of a terminal reads the computer instruction from the computer-readable storage medium, and the processor executes the computer instruction to cause the terminal to execute the image frame display method provided in various implementations according to the foregoing aspects.

The technical solutions provided in the embodiments of this application have at least the following beneficial effects:

After receiving a first rendered element rendered by a terminal and a second rendered element rendered by a server, the terminal receives an interactive instruction that is used for determining a display mode of a first image element and a second image element and transmitted by the server, to enable the terminal to display the first image element and the second image element on an image frame through the display mode indicated by the interactive instruction, such that the process of rendering some of image elements is transferred to the terminal, thereby improving the quality of rendering some of the image elements while ensuring the requirement of low latency of an image frame rendering process.

### BRIEF DESCRIPTION OF THE DRAWINGS

FIG. 1 illustrates a data sharing system according to an example embodiment of this application.

FIG. 2 is a schematic flowchart of an image frame display method according to an example embodiment of this application.

FIG. 3 is a schematic diagram of an image frame display method according to an example embodiment of this application.

FIG. 4 is a method flowchart of an image frame display method according to an example embodiment of this application.

FIG. 5 is a schematic diagram of rendering a first rendered image according to the embodiment shown in FIG. 4.

FIG. 6 is a schematic diagram of rendering a second rendered image according to the embodiment shown in FIG. 4.

FIG. 7 is a schematic diagram of an image frame display process when there is no coupling relationship according to the embodiment shown in FIG. 4.

FIG. 8 is a schematic diagram of an image frame display process when there is a coupling relationship according to the embodiment shown in FIG. 4.

FIG. 9 is a schematic diagram of an image frame in a game scenario according to the embodiment shown in FIG. 4.

FIG. 10 is a schematic diagram of an image frame display process according to an example embodiment of this application.

FIG. 11 is a block diagram of an image frame display apparatus according to an example embodiment of this application.

FIG. 12 is a block diagram of an image frame display apparatus according to an example embodiment of this application.

FIG. 13 is a schematic structural diagram of a computer device according to an example embodiment of this application.

FIG. 14 is a schematic structural diagram of a computer device according to an example embodiment of this application.

### DESCRIPTION OF EMBODIMENTS

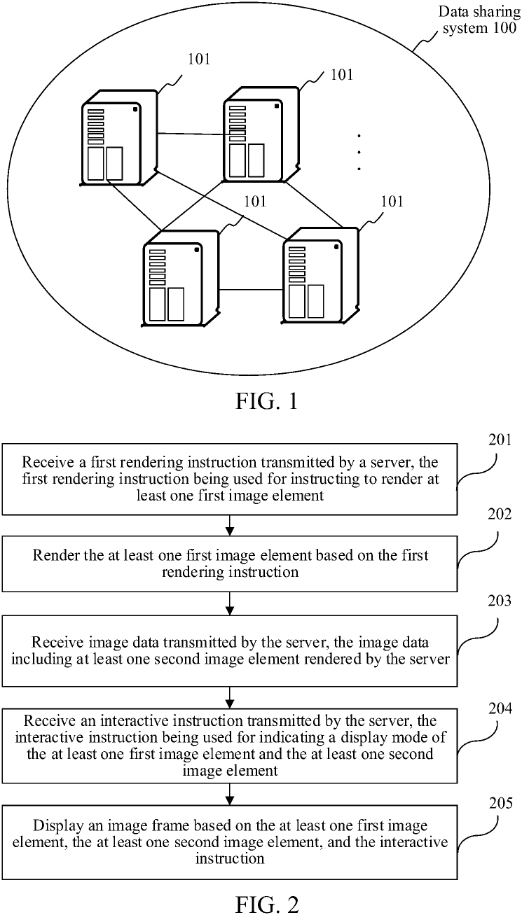

FIG. 1 illustrates a data sharing system according to an embodiment of this application. As shown in FIG. 1, a data sharing system 100 is a system for sharing data between nodes, and the data sharing system may include a plurality of nodes 101, which may refer to clients in the data sharing system. Each node 101 may receive input information during normal work, and maintain shared data in the data sharing system based on the received input information. To ensure information intercommunication in the data sharing system, information connection may exist between nodes in the data sharing system, so that information can be transmitted between the nodes through the information connection. For example, when any node in the data sharing system receives input information, other nodes in the data sharing system obtain the input information according to a consensus algorithm, and store the input information as shared data, so that data stored on all nodes in the data sharing system is consistent.

A cloud server may be the data sharing system 100 as shown in FIG. 1. For example, the function of the cloud server may be realized through a blockchain.

Through an image frame display method, part of image element rendering work is transferred from a server to a terminal, thereby reducing rendering burden of the server, and avoiding poor quality of a rendered image after the client decodes and restores lossy compressed image data due to the need to compress the rendered image in a lossy compression manner because the volume of image data to be rendered on the server is large, such that image quality loss caused by lossy compression performed on the image by the server is reduced, and the quality of an image displayed on the terminal is enhanced.

FIG. 2 is a schematic flowchart of an image frame display method according to an example embodiment of this application. The method may be executed by a computer device, and the computer device may be a terminal. For example, the method may be executed by a client among terminals. As shown in FIG. 2, the terminal may perform the following steps to display an image frame.

Step 201: Receive a first rendering instruction transmitted by a server, the first rendering instruction being used for instructing to render at least one first image element.

In this embodiment of this application, the terminal receives first rendering instructions transmitted by a server.

Optionally, the first rendering instructions are used for instructing the terminal to call rendering functions to render first image elements.

The first image elements are some of image elements in a complete picture to be displayed on a display interface of the terminal. For example, taking the terminal displaying a game picture as an example, a complete game picture to be displayed on the display interface of the terminal includes a game scenario picture as well as a skill control, an inventory control, an avatar control, a thumbnail map control, and a status icon, etc. superimposed on the game scenario picture. The first image elements may be some of them (for example, at least one of the status icon, the skill control, and the inventory control).

The first rendering instructions may include function names of the rendering functions and related parameters corresponding to the rendering functions.

Step 202: Render the at least one first image element based on the first rendering instruction.

In this embodiment of this application, the terminal renders the at least one first image element based on the received first rendering instruction.

During a rendering operation, the terminal needs to receive a plurality of first rendering instructions, and call a plurality of rendering functions based on the plurality of first rendering instructions to implement a rendering process, so as to obtain the first image element corresponding to the plurality of first rendering instructions.

In a possible implementation, the rendering operation for rendering the first image element corresponds to a group of first rendering instructions. Each first rendering instruction in the group of first rendering instructions corresponds to one or more rendering functions, and each first rendering instruction includes a function name of a rendering function and related parameters of the rendering function.

The first image element may be rendered in the terminal.

Step 203: Receive image data transmitted by the server, the image data including at least one second image element rendered by the server.

The second image element may be an image element to be displayed on the display interface of the terminal other than the first image element. For example, taking the terminal displaying the game picture as an example, when the first image elements include a status icon, a skill control, and an inventory control, the second image elements may include a game scenario picture, an avatar control, and a thumbnail map control.

In this embodiment of this application, the terminal receives the image data transmitted by the server, where the image data may be data corresponding to the at least one second image element rendered by the server.

In a possible implementation, when the image data transmitted by the server is compressed data obtained by encoding and compressing the second image element, upon the reception of the image data transmitted by the server, the terminal performs image decoding on the image data to obtain a decompressed second image element.

The image quality of the decompressed second image element may be lower than the image quality of the second image element rendered on the server.

In this embodiment of this application, when an image quality requirement is satisfied, the server may perform lossy compression on the rendered second image element to reduce as much data volume of the image data as possible, thereby achieving effects of lowering latency of transmitting image elements between the server and the terminal and saving traffic resources of the terminal.

Step 204: Receive an interactive instruction transmitted by the server, the interactive instruction being used for indicating a display mode of the at least one first image element and the at least one second image element.

In this embodiment of this application, the terminal respectively receives the first rendering instruction and the image data transmitted by the server, and it can be determined that the terminal not only obtains the first image element rendered by the terminal, but also obtains the second image element rendered by the server. The terminal receives an interactive instruction transmitted by the server, so that how and when to display the first image element and the second image element in the same image frame can be determined though the interactive instruction.

The display mode of the first image element and the second image element may be separate display, or the first image element and the second image element are synchronously displayed in the image frame, or a transparency synthesis operation on the first image element and the second image element in advance is required, and all the image elements undergone transparency synthesis are displayed on the image frame.

In a possible implementation, the interactive instruction may include a first interactive instruction and a second interactive instruction, and the terminal may receive the first interactive instruction for the first image element and the second interactive instruction for the second image element transmitted by the server.

Step 205: Display an image frame based on the at least one first image element, the at least one second image element, and the interactive instruction.

In this embodiment of this application, the terminal obtains the at least one first image element rendered by the terminal, obtains the second image element by decompressing the image data, and may display, based on the display mode indicated by the interactive instruction, the image frame including the first image element and the second image element.

To sum up, in a solution shown in this embodiment of this application, after receiving a first rendered element rendered by a terminal and a second rendered element rendered by a server, the terminal receives an interactive instruction that is used for determining a display mode of a first image element and a second image element and transmitted by the server, to enable the terminal to display the first image element and the second image element on an image frame through the display mode indicated by the interactive instruction, such that the process of rendering some of image elements is transferred to the terminal, and image elements respectively rendered by the terminal and the server can be displayed in a synthesized manner, thereby improving the quality of rendering some of the image elements while ensuring the requirement of low latency of an image frame rendering process.

The solution shown in the foregoing embodiment of this application may be applied into a scenario of rendering a static game interface of a local game. The static game interface may be a game interface display picture, where the game interface display picture includes at least one control element and at least one background picture. The method may be executed by a terminal running a game. The terminal receives a first rendering instruction transmitted by a game server. The first rendering instruction may be used for instructing to render at least one control element in the game. The terminal may render the at least one control element based on the first rendering instruction. Then, the terminal receives picture data which includes at least one background picture and is transmitted by the game server, where the at least one background picture is rendered by the game server. The terminal receives an interactive instruction transmitted by the game server, where the interactive instruction may be used for indicating a display mode of the at least one control element and the at least one background picture. The terminal displays, according to the display mode, the game interface display picture including the at least one control element and the at least one background picture.

In another possible implementation, the solution shown in this embodiment of this application may be applied into a scenario of rendering a dynamic game interface of a local game, where the dynamic game interface may be a virtual scene display picture, and the virtual scene display picture includes at least one control element and at least one background picture that dynamically changes with time. The method may be executed by a terminal running a game. The terminal receives a first rendering instruction transmitted by a game server. The first rendering instruction may be used for instructing to render at least one control element in the game. The terminal may render the at least one control element based on the first rendering instruction. Then, the terminal receives picture data which includes at least one current background picture and is transmitted by the game server, where the current background picture may be a picture obtained by observing a three-dimensional virtual environment in a three-dimensional virtual scene from a first-person perspective of a virtual object controlled by the terminal, or a picture obtained by observing the three-dimensional virtual environment from a third-person perspective. The at least one current background picture is rendered by the game server. The terminal receives an interactive instruction transmitted by the game server, where the interactive instruction may be used for indicating a display mode of the at least one control element and the at least one current background picture. The terminal displays, according to the display mode, the virtual scene display picture including the at least one control element and the at least one current background picture.

In another possible implementation, the solution shown in this embodiment of this application may also be applied into a cloud game scenario to perform real-time rendering on a game image frame, where the game image frame may be a static game picture or a dynamic game picture, and the game image frame includes at least one control element and at least one background picture. The method may be executed by a terminal running a game. The terminal receives a first rendering instruction transmitted by a cloud game server. The first rendering instruction may be used for instructing to render at least one control element in the game. The terminal may render the at least one control element based on the first rendering instruction. Then, the terminal receives picture data which includes at least one current background picture and is transmitted by the cloud game server, where the current background picture may be a picture obtained by observing a three-dimensional virtual environment in a three-dimensional virtual scene from a first-person perspective of a virtual object controlled by the terminal, or a picture obtained by observing the three-dimensional virtual environment from a third-person perspective. The at least one current background picture is rendered by the game server. The terminal receives an interactive instruction transmitted by the cloud game server, where the interactive instruction may be used for indicating a display mode of the at least one control element and the at least one current background picture. The terminal displays, according to the display mode, the game image frame including the at least one control element and the at least one current background picture.

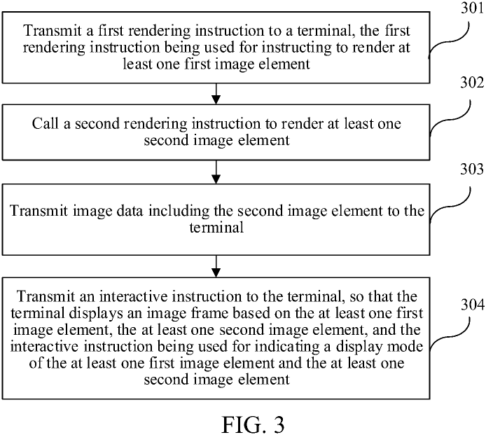

FIG. 3 is a schematic diagram of an image frame display method according to an example embodiment of this application. The method may be executed by a computer device, where the computer device may be a server. As shown in FIG. 3, the server may perform the following steps to display an image frame.

Step 301: Transmit a first rendering instruction to a terminal, the first rendering instruction being used for instructing to render at least one first image element.

Step 302: Call a second rendering instruction to render at least one second image element.

Step 303: Transmit image data including the second image element to the terminal.

Step 304: Transmit an interactive instruction to the terminal, so as to cause the terminal to display an image frame based on the at least one first image element, the at least one second image element, and the interactive instruction, the interactive instruction being used for indicating a display mode of the at least one first image element and the at least one second image element.

In a possible implementation, the server may be a separate physical server, or a server cluster or distributed system composed of multiple physical servers, or a cloud server that provides cloud services, cloud databases, cloud computing, cloud functions, cloud storage, network services, cloud communications, middleware services, domain name services, security services, content delivery network (CDN), and basic cloud computing services such as big data and artificial intelligence platforms. The terminal may be a smartphone, a tablet computer, a notebook computer, a desktop computer, a smart speaker, a smartwatch, etc., but is not limited thereto. The terminal and the server may be connected directly or indirectly through wired or wireless communication. This is not limited in this application.

To sum up, in a solution shown in this embodiment of this application, after receiving a first rendered element rendered by a terminal and a second rendered element rendered by a server, the terminal receives an interactive instruction that is used for determining a display mode of a first image element and a second image element and transmitted by the server, to enable the terminal to display the first image element and the second image element on an image frame through the display mode indicated by the interactive instruction, such that the process of rendering some of image elements is transferred to the terminal, and image elements respectively rendered by the terminal and the server can be displayed in a synthesized manner, thereby improving the quality of rendering some of the image elements while ensuring the requirement of low latency of an image frame rendering process.

The solution shown in the foregoing embodiment of this application may be applied into a scenario of rendering a virtual scene picture of a cloud game.

In this embodiment of this application, there are two ways to render an image. One is to render an image through video streaming, and the other is to render an image through application programming interface (API) forwarding.

Rendering an image through video streaming is to perform a rendering operation on a server. The server captures a rendered image to perform an encoding and compression operation, and then transmits the compressed image to a client through a network. Upon the reception of compressed image data, the client decompresses the image data and displays a decompressed image on the client. During rendering the image through video streaming, the rendered image is encoded and compressed on the server, so as to reduce the bandwidth required for network transmission. Lossy compression is generally adopted in the encoding and compression operation to maximize compression. However, during the client restoring lossy compressed data, the quality of a restored image is lowered to a certain extent. Rendering in this way may cause a certain blur effect for some icons or text superimposed on a game interface, and consequently, affect user experience.

Rendering an image through API forwarding is to perform a rendering operation on a server. The server converts a rendering instruction into a corresponding rendering function interface, and then transmits a function name and parameters corresponding to the function interface to a client through a network. Upon the reception of corresponding data, the client executes a corresponding function call to complete the rendering operation, and displays the rendered image. During rendering through API forwarding, the rendering operation may be completed by the client. Therefore, in a scenario of rendering a game picture, corresponding texture data of a game needs to be transmitted from the server to the client for use in subsequent rendering. Since the size of the texture data of the game is relatively large, the process of transmitting the texture data to the client is relatively time-consuming, which is unfavorable for such scenario that requires low latency in image rendering in a cloud game.

In addition, during rendering in this way, it is necessary to query a current rendering status. For example, whether there is an error during the execution of a current rendering instruction may be checked by calling a glGetError() function related to OpenGL/OpenGL ES to return a corresponding status. In order to complete the rendering operation of one single image frame, hundreds of rendering instructions may need to be introduced. In general, to ensure correctness of rendering steps, the glGetError() function is to be called frequently, and corresponding processing is to be made in a timely manner according to a current error return value. Since the server and the client are generally connected by a network, network latency between the server and the client is introduced in each glGetError() function call. Calling glGetError() or a similar status query function too many times will greatly increase latency of the cloud game.

In this embodiment of this application, different image elements are rendered in different manners, that is, some image elements are rendered by the server, and the others are rendered by the terminal. Finally, the terminal determines a display mode corresponding to the image elements rendered in both ways, and displays an image frame according to the determined display mode, thereby balancing image quality requirements on different image elements and a low latency requirement of image frame rendering during displaying each image frame.

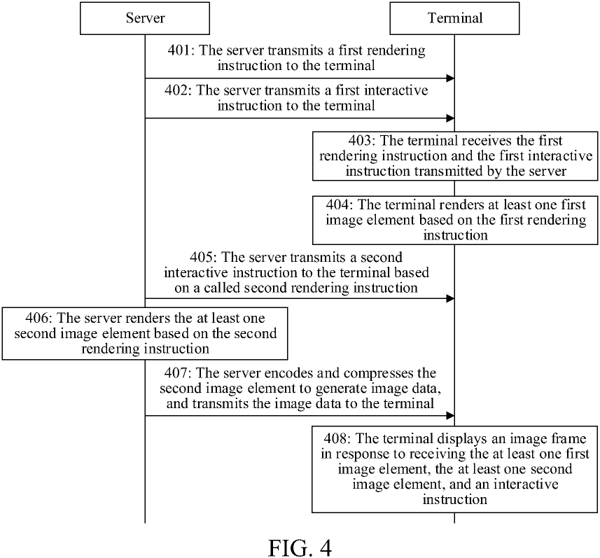

FIG. 4 is a method flowchart of an image frame display method according to an example embodiment of this application. The foregoing method may be executed interactively by a terminal and a server. As shown in FIG. 4, the terminal performs the following steps to display the image frame.

Step 401: A server transmits a first rendering instruction to a terminal.

In this embodiment of this application, when a first image element is a to-be-rendered image element, the server transmits the first rendering instruction to the terminal.

The first rendering instruction may be used for instructing to render at least one first image element. The to-be-rendered image element may be used for indicating an image element to be rendered in each image frame corresponding to a rendering operation when the server receives an instruction to perform the rendering operation. The first image element may be used for indicating to-be-rendered image elements in the image frame to be rendered by the terminal.

Before calling the first rendering instruction, the server may determine in advance which part of the to-be-rendered image elements is to be directly rendered by the server, and which part is to be rendered by the terminal.

In a possible implementation, the server actively determines the first image element and a second image element in the image frame according to a requirement of the image frame.

The requirement of the image frame may include at least one of complexity of image rendering and a display quality requirement of the terminal for image elements.

For example, when the scenario of rendering the image frame is a game scenario, one rendering operation that the server needs to initiate may be to draw a sphere, and another rendering operation may be to draw an arrow key. During displaying the sphere and the arrow key in the image frame, a process of moving the sphere can be realized by tapping the arrow key. In this case, according to the requirement of the image frame, an active selection on whether to render the sphere and the arrow key through the terminal or the server can be made. When the display quality requirement for the sphere in the image frame are higher than the display quality requirement for the arrow key, or the complexity of the image rendering corresponding to the sphere is lower than the complexity of the image rendering corresponding to the arrow key, the arrow key may be rendered on the server, i.e., rendered by calling a second rendering instruction, and the sphere may be rendered on the terminal, i.e., rendered by calling the first rendering instruction. Otherwise, when the display quality requirement for the sphere in the image frame is lower than the display quality requirement for the arrow key, or the complexity of the image rendering corresponding to the sphere is higher than the complexity of the image rendering corresponding to the arrow key, the sphere may be rendered on the server, i.e., rendered by calling the second rendering instruction, and the arrow key may be rendered on the terminal, i.e., rendered by calling the first rendering instruction.

In a possible implementation, in response to a specified parameter of the to-be-rendered image element satisfying a terminal rendering condition, the to-be-rendered image element is determined as the first image element; and in response to the specified parameter of the to-be-rendered image element not satisfying the terminal rendering condition, the to-be-rendered image element is determined as the second image element.

The specified parameter may include at least one of image complexity and a display quality requirement.

In a possible implementation, the server automatically determines the first image element and the second image element in the image frame by comparing the specified parameter corresponding to the requirement of the image frame with a predetermined parameter threshold.

For example, in response to the image complexity corresponding to the to-be-rendered image element being lower than a first threshold, the first rendering instruction is called, and the to-be-rendered image element is determined as a to-be-rendered first image element; and in response to the image complexity corresponding to the to-be-rendered image element being higher than the first threshold, the second rendering instruction is called, and the to-be-rendered image element is determined as a to-be-rendered second image element.

In this embodiment of this application, since the rendering capability of the server is generally stronger than that of the terminal, the server may analyze the image complexity of to-be-rendered image elements, and determine to render an image element having high image complexity on the server and to render an image element having low image complexity on the terminal, so as to ensure the rendering efficiency of image elements.

For another example, in response to the display quality requirement corresponding to the to-be-rendered image element being higher than a second threshold, the first rendering instruction is called, and the to-be-rendered image element is determined as the to-be-rendered first image element; and in response to the display quality requirement corresponding to the to-be-rendered image element being lower than the second threshold, the second rendering instruction is called, and the to-be-rendered image element is determined as the to-be-rendered second image element.

In this embodiment of this application, the server may analyze the display quality requirement of to-be-rendered image elements, and determine to render an image element having a low display quality requirement on the server and to render an image element having a high display quality requirement on the terminal. Since the image element rendered on the terminal does not need to be compressed and transmitted, and can be directly displayed with a relatively high display quality, so as to ensure the image quality as much as possible.

In a possible implementation, the server transmits to the terminal a rendering function name corresponding to the first rendering instruction and related parameters used during rendering the at least one first image element through a remote procedure call (RPC).

The RPC refers to a function allowing a node to request for a service provided by another node. In this embodiment of this application, the server transmits the first rendering instruction to the terminal through the RPC, so that the terminal may start rendering of the first image element as soon as possible, so as to reduce latency in displaying the image frame of the terminal.

Step 402: The server transmits a first interactive instruction to the terminal.

In this embodiment of this application, in response to determining to render the first image element, the server transmits to the terminal the first interactive instruction determined based on the first rendering instruction.

The first interactive instruction may be used for indicating a display mode of the first image element, and may include at least one of first interaction flag information and a first interaction parameter. The first interactive instruction may be used for indicating whether the first image element rendered by the terminal needs to be synchronized or synthesized during display.

The first interaction flag information is used for indicating the display mode of the first image element, for example, whether the first image element needs to be synchronized with the second image element, whether the first image element needs to be synthesized with the second image element, and the like. The first interaction parameter includes parameters required by the display mode indicated by the first interaction flag information, for example, synchronization time information corresponding to synchronous display, and transparency information required for synthesis display.

In a possible implementation, the first interactive instruction is received by the terminal through an API provided by a graphics card driver of the server and is transmitted to the terminal together with the first rendering instruction.

Step 403: The terminal receives the first rendering instruction and the first interactive instruction transmitted by the server.

In this embodiment of this application, the terminal receives the first rendering instruction and the first interactive instruction transmitted by the server.

In a possible implementation, the terminal receives the first interactive instruction that corresponds to the first image element and is transmitted by the server.

Step 404: The terminal renders the at least one first image element based on the first rendering instruction.

In this embodiment of this application, the terminal may call, based on the received first rendering instruction, a rendering function interface corresponding to the first rendering instruction in the terminal, so as to perform a rendering operation to render the at least one first image element.

In a possible implementation, the terminal obtains the rendering function name included in the first rendering instruction, and related parameters used during rendering the at least one first image element; and call, based on the rendering function name, a function interface corresponding to the rendering function name, so as to render the at least one first image element through the function interface and the related parameters.

The first rendering instruction may include a rendering function name of a rendering function and related parameters corresponding to the rendering function.

For example, when the first rendering instruction is used for instructing the terminal to execute glTexImage2D function, the rendering function name included in the first rendering instruction is glTexImage2D function, the related parameters may be {GLenum target, Glint level, Glint internalformat, GLsizei width, GLsizei height, Glint border, GLenum format, GLenum type, const void*data}, and the related parameters may include data related to texture mapping.

Parameter target is constant GL_TEXTURE_2D. Parameter level indicates the level of a texture image with multi-level resolution. Parameters, width and height, provide the length and width of the texture image, and parameter border is the texture border width. Parameters internalformat, format, and type describe the format and data type of texture mapping, and const void*data is used for indicating memory allocation.

When the rendering function corresponding to the first rendering instruction is a texture-related function, texture data used during rendering the first image element may be put in the related parameters and transmitted to the terminal together with the related parameters.

For example, the server may call the rendering function specified by the graphics card driver, where the rendering function may be beginRPCxxx(flag, data), so that the first image element enters a terminal rendering mode, and then the first rendering instruction for rendering the first image element is to be transmitted to the terminal through the RPC. The server may end the terminal rendering mode of the first image element by calling the rendering function specified by the graphics card driver, where the rendering function may be endRPCxxx(flag, data).

In this embodiment of this application, the server may trigger the terminal to start and stop rendering through beginRPCxxx(flag, data) and endRPCxxx(flag, data), so that an image element rendering process of the terminal may be executed under the control of the server, thereby improving controllability of cooperative rendering by the terminal and the server.

The flag is a flag item in the rendering function. The flag item may correspond to the first interaction flag information and may represent whether a display image rendered on the terminal needs to be synchronized with a display image rendered on the server, may also be used for indicating whether the display image rendered by the terminal and the display image rendered by the server need to be synthesized, and may also indicate other different behaviors. The data is a data item in the rendering function. The data item may correspond to the first interaction parameter. The data item may represent a timestamp on which synchronization display of an image rendered by the terminal and an image rendered by the server depends or other data that may be used during waiting for synchronization, may also represent a transparency parameter, i.e., an alpha coefficient, during transparency synthesis display of the image rendered by the terminal and the image rendered by the server, and may also represent a set of other data.

Step 405: The server transmits a second interactive instruction to the terminal based on the called second rendering instruction.

In this embodiment of this application, in response to determining to call the second rendering instruction, the server transmits the second interactive instruction to the terminal based on the second rendering instruction.

The second interactive instruction may be used for indicating the display mode of the second image element, and may include at least one of second interaction flag information and a second interaction parameter. The second interactive instruction may be used for indicating whether the second image element rendered by the server needs to be synchronized or synthesized when displayed.

The second interaction flag information is used for indicating the display mode of the second image element, for example, whether the second image element needs to be synchronized with the first image element, whether the second image element needs to be synthesized with the first image element, and the like. The second interaction parameter includes parameters required by the display mode indicated by the second interaction flag information, for example, synchronization time information corresponding to synchronous display, and transparency information required for synthesis display.

In a possible implementation, the server directly calls the API provided by a local graphics card driver to execute the rendering function corresponding to the second rendering instruction. During the calling process, the server obtains the corresponding second interactive instruction, and transmits the second interactive instruction to the terminal.

For example, the server may call the rendering function specified by the graphics card driver, where the rendering function may be beginLocalxxx(flag, data), so that the second image element enters a server rendering mode, and then the second image element is rendered through the second rendering instruction. The server may end the server rendering mode of the second image element by calling the rendering function specified by the graphics card driver, where the rendering function may be endLocalxxx (flag, data).

The flag is a flag item in the rendering function. The flag item may correspond to the second interaction flag information and may represent whether the display image rendered by the server needs to be synchronized with the display image rendered by each terminal, may also be used for representing whether the display image rendered by the server and the display image rendered by each terminal need to be synthesized, and may also represent other different behaviors. And the data is a data item in the rendering function. The data item may correspond to the second interaction parameter. The data item may represent a timestamp on which synchronization display of an image rendered by the server and an image rendered by each terminal depends or other data that may be used during waiting for synchronization, may also represent a transparency parameter, i.e., an alpha coefficient, during transparency synthesis display of the image rendered by the server and the image rendered by each terminal, and may also represent a set of other data. The server may transmit the flag item and the data item as the second interactive instruction to the terminal.

In a possible implementation, the terminal receives the second interactive instruction that corresponds to the second image element and is transmitted by the server.

Step 406: The server renders the at least one second image element based on the second rendering instruction.

In this embodiment of this application, the server executes, based on the rendering function corresponding to the second rendering instruction, the rendering function through the graphics card driver of the server to render the at least one second image element.

In a possible implementation, the server directly calls an API provided by the graphics card driver in the server to execute the rendering function corresponding to the second rendering instruction, to generate at least one rendered second image element.

Step 407: The server encodes and compresses the second image element to generate image data, and transmits the image data to the terminal.

In this embodiment of this application, the server performs an image encoding operation on the rendered second image element, so as to perform data compression on the second image element, and transmits the encoded and compressed image data to the terminal.

In a possible implementation, the server encodes and compresses the second image element by lossy compression to generate image data, and transmits the image data to the terminal.

In this embodiment of this application, the server may reduce the data volume to be transmitted as much as possible through lossy compression within an acceptable range of image quality loss, thereby reducing the latency of image data transmission between the server and the terminal.

Upon the reception of the image data, the terminal decompresses the image data by an image decoding operation to obtain a decompressed second image element.

Step 408: The terminal displays the image frame in response to receiving at least one first image element, at least one second image element, and an interactive instruction.

In this embodiment of this application, in response to receiving the first image element and the second image element, the terminal displays, according to the display mode indicated by the first interactive instruction and the second interactive instruction, an image frame including the first image element and the second image element.

In a possible implementation, the display mode of the first image element and the second image element is determined based on the first interaction flag information in the first interactive instruction and the second interaction flag information in the second interactive instruction; and the at least one first image element and the at least one second image element are displayed according to the display mode of the first image element and the second image element, to display the image frame.

The first interaction flag information is used for indicating the display mode of the first image element, and the second interaction flag information is used for indicating the display mode of the second image element.

For example, the display mode of the first image element and the second image element may be at least one of a synchronous display mode, a transparency synthesis display mode, and a separate display mode.

In a possible implementation, in response to the display mode being synchronous display, the first interactive instruction includes the first interaction parameter, the second interactive instruction includes the second interaction parameter, and the first interaction parameter and the second interaction parameter respectively include synchronization time indication information of the first image element and of the second image element. The terminal synchronously displays image elements among the at least one first image element and the at least one second image element that match the synchronization time indication information, so as to display an image frame.

At least one of the first interaction parameter and the second interaction parameter includes a timestamp parameter.

For example, when image element A among at least one first image element is determined to be displayed synchronously, and timestamp information in a first interaction parameter corresponding to image element A indicates moment a, a terminal needs to wait for synchronization. When the terminal determines that image element B among second image elements also needs to be displayed synchronously, and timestamp information in a second interaction parameter corresponding to image element B also indicates moment a, image element A and image element B are displayed synchronously at moment a, that is, image element A and image element B are displayed synchronously in an image frame.

Or, for the first image element and the second image element of which synchronization time indication information matches, the terminal may determine, based on the synchronization time indication information of the first image element and the second image element, a synchronization moment at which the first image element and the second image element are to be displayed synchronously; and in response to arrival of the synchronization moment, the terminal may display the first image element and the second image element synchronously. The synchronization time indication information may be a timestamp parameter.

For example, in response to the display mode of the first image element and the second image element being a synchronous display mode, the synchronization moment when the first image element and the second image element are to be displayed synchronously is determined based on the timestamp parameter. In response to the arrival of the synchronization moment, the terminal displays an image frame synchronously displaying the first image element and the second image element. When the first image element and the second image element have a coupling relationship, and the time of completion of rendering of the first image element and the second image element is different, the synchronization waiting process may be performed, such that the problem that image elements having a coupling relationship are unable to be displayed synchronously due to different rendering modes is avoided, thereby enabling the first image element and the second image element rendered at different time to be displayed on the image frame synchronously.

In a possible implementation, in response to the display mode being transparency synthesis display, the first interactive instruction includes the first interaction parameter, the second interactive instruction includes the second interaction parameter, and the first interaction parameter and the second interaction parameter respectively include transparency information of the first image element and the second image element; the terminal determines transparency of the at least one first image element and the at least one second image element based on the transparency information of the at least one first image element and the at least one second image element; and the at least one first image element and the at least one second image element are displayed in a synthesized manner based on the transparency of the at least one first image element and the at least one second image element, to display an image frame.

The transparency may be a parameter indicating a transparency degree during displaying the image element, and a transparent overlapping effect can be obtained during synthesis of image elements through respective transparency of the first image element and the at least one second image element.

For example, the first image element and the second image element displayed in the transparency synthesis mode may be displayed synchronously or separately. When the first image element and the second image element are displayed synchronously, the synchronized first image element and second image element may be displayed in a transparency synthesis mode. In the case that the first image element and the second image element are displayed separately, the terminal may directly perform transparency synthesis after receiving the first image element and the second image element, and display the image generated after the synthesis in the image frame. Through the foregoing process, the first image element rendered by the terminal and the second image element rendered by the server may be synthesized based on the transparency of the first image element and the second image element, and then the synthesized image may be displayed in the image frame, thereby improving the display effect of the synthesized image in the image frame.

In a possible implementation, in response to the display mode being separate display, the terminal separately displays the at least one first image element and the at least one second image element, so as to display an image frame.

The separate display is used for indicating that there is no coupling relationship between the at least one first image element and the at least one second image element, which are separately displayed in the image frame after rendered.

If both the first interaction flag information and the second interaction flag information indicate that the first image element and the second image element are not to be displayed synchronously, the first image element and the second image element may be directly displayed on the image frame, or the first image element and the second image element may be synthesized into one single image, and the synthesized image may be displayed on the image frame.

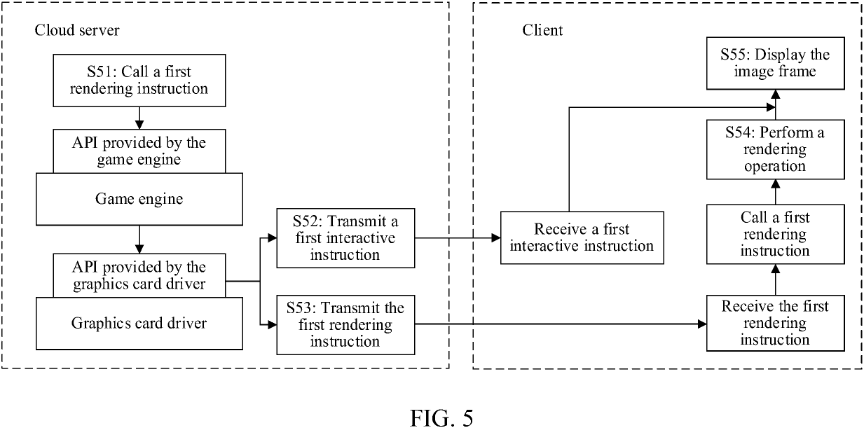

For example, FIG. 5 is a schematic diagram of rendering a first rendered image according to an embodiment of this application. As shown in FIG. 5, when a rendering process is applied to a scenario of rendering a game interface of a cloud game, a cloud server first receives an instruction to start rendering (S51), controls a graphics card driver based on an API provided by a game engine corresponding to the cloud game, and transmits a first rendering instruction (S53) and a first interactive instruction corresponding to the first rendering instruction to the client (S52) based on the API provided by the graphics card driver. Then, a client respectively receives the first rendering instruction and the first interactive instruction. The client calls a corresponding rendering function based on the received first rendering instruction to execute a corresponding rendering operation (S54) to render a first image element. The client determines a display mode of the rendered first image element on the client based on the received first interactive instruction, and displays a first graphic element based on the display mode (S55).

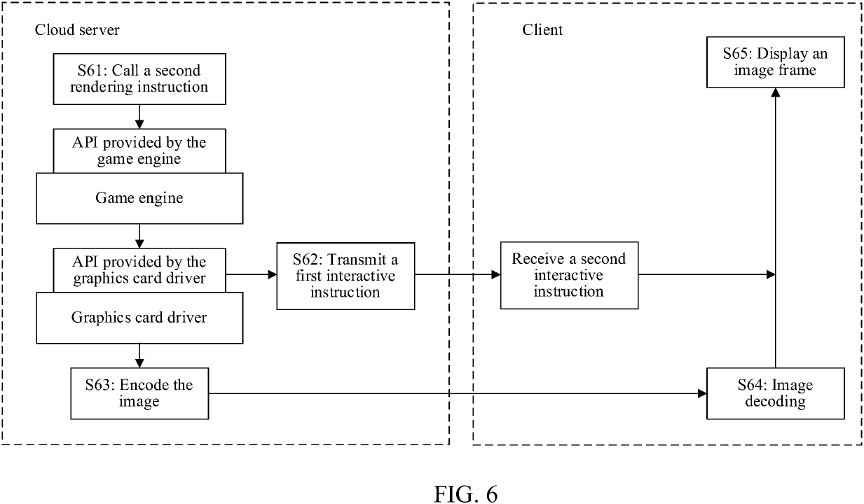

In addition, FIG. 6 is a schematic diagram of rendering a second rendered image according to an embodiment of this application. As shown in FIG. 6, when a rendering process is applied to a scenario of rendering a game interface of a cloud game, a cloud server first receives instruction to start rendering, calls a second rendering instruction (S61), and controls a graphics card driver based on an API provided by a game engine corresponding to the cloud game. The cloud server may obtain a corresponding second interactive instruction based on the second rendering instruction through the graphics card driver, and transmit the second interactive instruction to a terminal through the API provided by the graphics card driver (S62). The cloud driver may execute, based on the API provided by the graphics card driver, a rendering function corresponding to the second rendering instruction to render a second image element, perform image encoding on the second image element though the graphics card driver to generate corresponding image data (S63), and transmit the image data to the terminal. The terminal decodes the received image data to obtain a decoded second image element (S64), and displays an image frame based on a display mode of the second image element in the image frame indicated by the obtained second interactive instruction (S65).

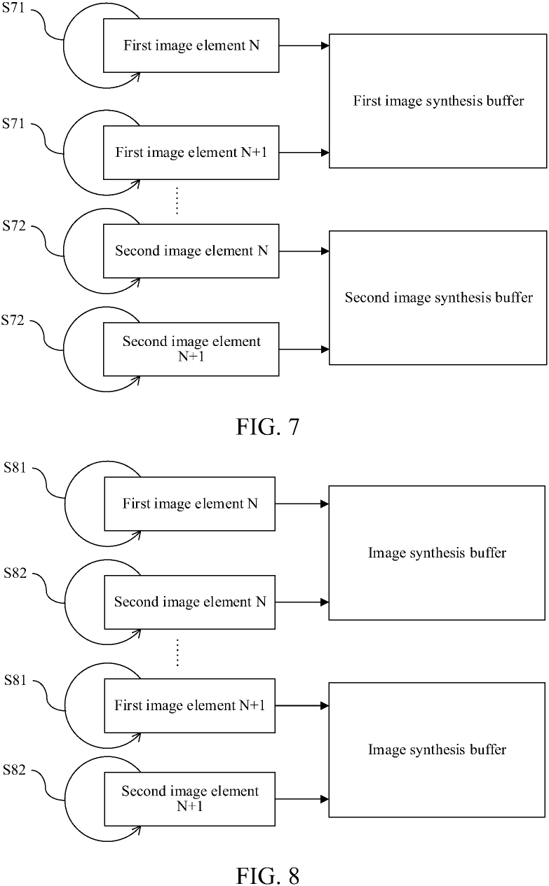

For example, there may be or may not be a coupling relationship between the first image element and the second image element. FIG. 7 is a schematic diagram of an image frame display process. When there is no coupling relationship according to an embodiment of this application. As shown in FIG. 7, a terminal reads a first interactive instruction corresponding to each first image element, and may determine, based on corresponding first interaction flag information, whether each first image element has a synchronization or synthesis relationship with another second image element (S71), when there is no synchronization relationship and synthesis relationship, cache each rendered first image element in a first image synthesis buffer, and display an image frame based on each first image element in the first image synthesis buffer. Similarly, the terminal reads a second interactive instruction corresponding to each second image element, and may determine, based on corresponding second interaction flag information and timestamp parameters, whether each second image element has a synchronization or synthesis relationship with another first image element (S72), when there is no synchronization relationship and synthesis relationship, cache each rendered second image element in a second image synthesis buffer, and display an image frame based on each second image element in the second image synthesis buffer. The first image element and the second image element may exist in the finally displayed image frame, but do not affect each other.

For example, the first image element rendered by the terminal is a game LOGO, which may be a display icon of a current network status. Since the display icon of the current network status does not correspond to a specific virtual scene, it is necessary to synchronize a display image of the virtual scene rendered by a server and a display icon of the current network status rendered by the terminal. The rendered display icon of the current network status is cached in the first image synthesis buffer, and the rendered virtual scene is cached in the second image synthesis buffer, and finally, an image frame is displayed.

FIG. 8 is a schematic diagram of an image frame display process when there is a coupling relationship according to an embodiment of this application. As shown in FIG. 8, a terminal reads a first interactive instruction corresponding to each first image element, and may determine, based on corresponding first interaction flag information and timestamp parameters, whether each first image element has a synchronization or synthesis relationship with another second image element (S81), when there is a synchronization relationship and a synthesis relationship, cache in a same image synthesis buffer each rendered first image element and the second image element having a synchronization relationship or a synthesis relationship, and display an image frame based on the first image element and the second image element in the image synthesis buffer. Similarly, the terminal reads a second interactive instruction corresponding to each second image element, and may determine, based on corresponding first interaction flag information and timestamp parameters, whether each second image element has a synchronization or synthesis relationship with another first image element (S82), when there is a synchronization relationship and a synthesis relationship, cache in a same image synthesis buffer each rendered second image element and the first image element with a synchronization relationship or a synthesis relationship, and finally display an image frame based on the first image element and each second image element in the image synthesis buffer.

For example, when the first image element rendered by the terminal is a text description of a current scene or a related prop icon, transparency synthesis needs to be performed on the first image element rendered by the terminal and the second image element rendered by a server, and the second image element rendered by the server and the first image element rendered by the terminal need to be displayed synchronously. The specific synchronization process may be completed by synchronization between processes or threads, and the specific synchronization waiting behavior may be realized by CPU or GPU hardware.

In a possible implementation, in response to the image frame being a virtual scene picture, the first image element includes at least one of an icon, a graphic button corresponding to a virtual control, and a graphic including text content, superimposed on the virtual scene picture; and the second image element includes an image used for displaying the virtual scene in the virtual scene picture.

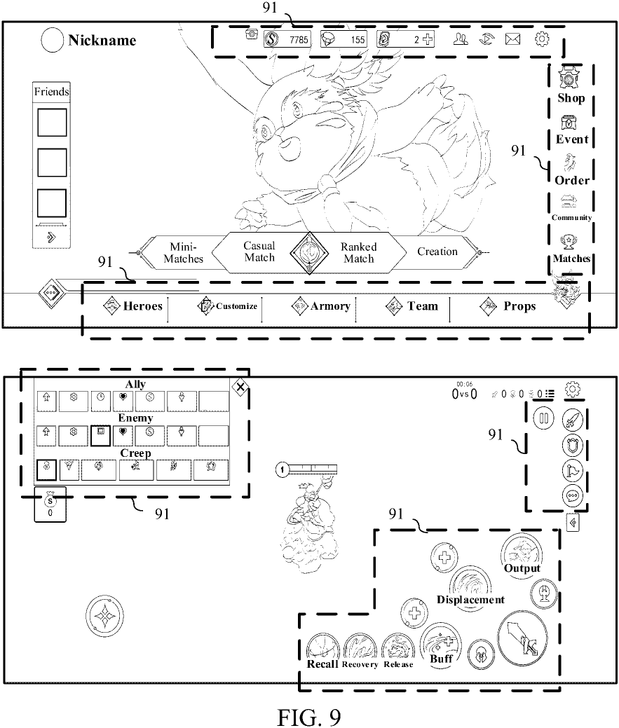

For example, FIG. 9 is a schematic diagram of an image frame in a game scenario according to an embodiment of this application. FIG. 9 is a game interface display picture and a virtual scene display picture in a game scenario. An icon, a graphic button corresponding to a virtual control, and a graphic including text content (91) superimposed on the virtual scene picture are image elements that may be optimized, that is, the part of the image elements may be determined as first image elements to be rendered by a terminal. This allows users to see the icon, button, or text with higher definition, without introducing too much network latency. According to these two requirements, most of rendering operations are performed on a server, and a small number of rendering operations are transferred to a client. The small number of rendering operations are mainly rendering operations on an icon, a button, text, or the like that do not need transferring a large amount of data between the server and the client.

To sum up, in a solution shown in this embodiment of this application, after receiving a first rendered element rendered by a terminal and a second rendered element rendered by a server, the terminal receives an interactive instruction that is used for determining a display mode of a first image element and a second image element and transmitted by the server, to enable the terminal to display the first image element and the second image element on an image frame through the display mode indicated by the interactive instruction, such that the process of rendering some of image elements is transferred to the terminal, and image elements respectively rendered by the terminal and the server can be displayed in a synthesized manner, thereby improving the quality of rendering some of the image elements while ensuring the requirement of low latency of an image frame rendering process.

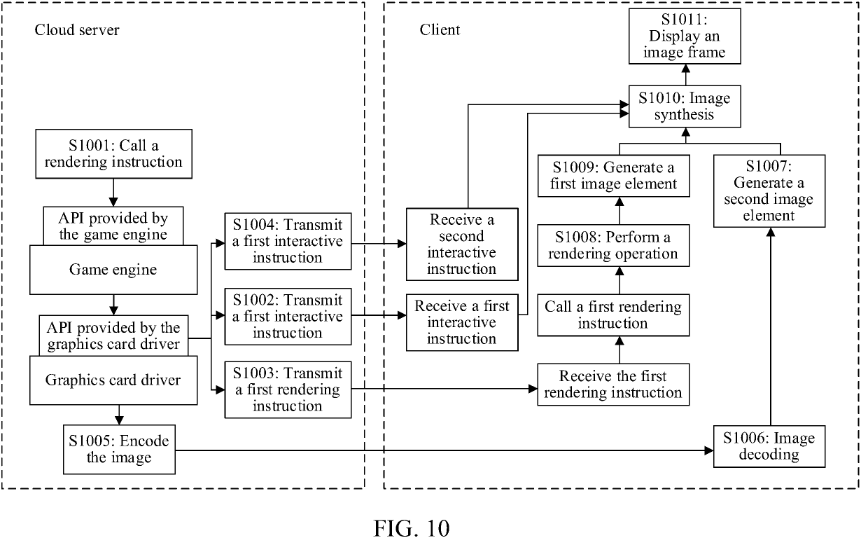

FIG. 10 is a schematic diagram of an image frame display process according to an example embodiment. As shown in FIG. 10, in response to the start of an image frame rendering process (S1001), a cloud server first receives an instruction to start rendering, and divides to-be-rendered image elements into a first image element and a second image element to perform rendering separately. During rendering the first image element, a graphics card driver may be controlled based on an API provided by a game engine corresponding to a cloud game. A first rendering instruction (S1003) and a first interactive instruction corresponding to the first rendering instruction may be transmitted to a client (S1002) based on the API provided by the graphics card driver. The client receives the first rendering instruction and the first interactive instruction, and calls a corresponding rendering function based on the received first rendering instruction to execute a corresponding rendering operation (S1008) to render the first image element (S1009). During rendering the second image element, a second rendering instruction may be called, and the graphics card driver may be controlled based on the API provided by the game engine corresponding to the cloud game. A corresponding second interactive instruction may be obtained based on the second rendering instruction through the graphics card driver. The second interactive instruction may be transmitted to the terminal through the API provided by the graphics card driver (S1004). The rendering function corresponding to the second rendering instruction may be executed based on the API provided by the graphics card driver to render the second image element. Image encoding may be performed on the second image element through the graphics card driver to generate corresponding image data (S1005), which is then transmitted to the terminal. The terminal decodes the received image data (S1006) to obtain a decoded second image element (S1007). The terminal synthesizes the first image element and the second image element based on the obtained first interactive instruction and the second interactive instruction (S1010), and displays an image frame corresponding to the synthesized image (S1011).

To sum up, in a solution shown in this embodiment of this application, after receiving a first rendered element rendered by a terminal and a second rendered element rendered by a server, the terminal receives an interactive instruction that is used for determining a display mode of a first image element and a second image element and transmitted by the server, to enable the terminal to display the first image element and the second image element on an image frame through the display mode indicated by the interactive instruction, such that the process of rendering some of image elements is transferred to the terminal, and image elements respectively rendered by the terminal and the server can be displayed in a synthesized manner, thereby improving the quality of rendering some of the image elements while ensuring the requirement of low latency of an image frame rendering process.

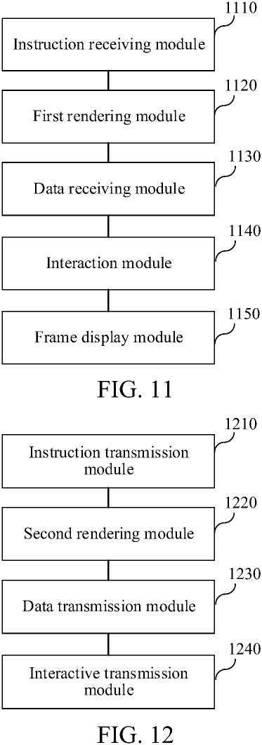

FIG. 11 is a block diagram of an image frame display apparatus according to an example embodiment. As shown in FIG. 11, the apparatus is configured to execute all or some of steps of the method shown in the corresponding embodiments shown in FIG. 2 or FIG. 4. The image frame display apparatus may include:
an instruction receiving module 1110, configured to receive a first rendering instruction transmitted by a server, the first rendering instruction being used for instructing to render at least one first image element;
a first rendering module 1120, configured to render the at least one first image element based on the first rendering instruction;
a data receiving module 1130, configured to receive image data transmitted by the server, the image data including at least one second image element rendered by the server;
an interaction module 1140, configured to receive an interactive instruction transmitted by the server, the interactive instruction being used for indicating a display mode of the at least one first image element and the at least one second image element; and
a frame display module 1150, configured to display the image frame based on the at least one first image element, the at least one second image element, and the interactive instruction.

In a possible implementation, the interaction module 1140 includes:
a first interaction submodule, configured to receive a first interactive instruction that corresponds to the first image element and is transmitted by the server; and
a second interaction submodule, configured to receive a second interactive instruction that corresponds to the second image element and is transmitted by the server.

In a possible implementation, the frame display module 1150 includes:
a mode determining submodule, configured to determine the display mode of the first image element and the second image element based on first interaction flag information in the first interactive instruction and second interaction flag information in the second interactive instruction, where the first interaction flag information is used for indicating the display mode of the first image element, and the second interaction flag information is used for indicating the display mode of the second image element; and
a frame display submodule, configured to display at least one first image element and at least one second image element according to the display mode of the first image element and the second image element, so as to display the image frame.

In a possible implementation, in response to the display mode being synchronous display, the first interactive instruction includes a first interaction parameter, the second interactive instruction includes a second interaction parameter, and the first interaction parameter and the second interaction parameter include synchronization time indication information of the first image element and the second image element, respectively; and
the frame display submodule includes:
   a synchronous display unit, configured to synchronously display image elements among the at least one first image element and the at least one second image element that match the synchronization time indication information, so as to display the image frame.

In a possible implementation, in response to the display mode being transparency synthesis display, the first interactive instruction includes a first interaction parameter, the second interactive instruction includes a second interaction parameter, and the first interaction parameter and the second interaction parameter include transparency information of the first image element and the second image element, respectively; and
the frame display submodule includes:
   a transparency determining unit, configured to determine transparency of the at least one first image element and the at least one second image element based on the transparency information of the at least one first image element and the at least one second image element; and
   a synthesis display unit, configured to perform transparency synthesis display on the at least one first image element and the at least one second image element based on the transparency of the at least one first image element and the at least one second image element, so as to display the image frame.

In a possible implementation, in response to the display mode being separate display, the frame display submodule includes:

a separate display unit, configured to separately display the at least one first image element and the at least one second image element, so as to display the image frame.

In a possible implementation, the first rendering module 1120 includes:
a function obtaining submodule, configured to obtain a rendering function name included in the first rendering instruction, and related parameters used during rendering the at least one first image element;
a first rendering submodule, configured to call, based on the rendering function name, a function interface corresponding to the rendering function name, so as to render the at least one first image element through the function interface and the related parameters.

In a possible implementation, in response to the image frame being a virtual scene picture, the first image element includes at least one of an icon, a graphic button of a virtual control, and a graphic including text content, superimposed on the virtual scene picture; and the second image element includes an image used for displaying the virtual scene in the virtual scene picture.

To sum up, in a solution shown in this embodiment of this application, after receiving a first rendered element rendered by a terminal and a second rendered element rendered by a server, the terminal receives an interactive instruction that is used for determining a display mode of a first image element and a second image element and transmitted by the server, to enable the terminal to display the first image element and the second image element on an image frame through the display mode indicated by the interactive instruction, such that the process of rendering some of image elements is transferred to the terminal, and image elements respectively rendered by the terminal and the server can be displayed in a synthesized manner, thereby improving the quality of rendering some of the image elements while ensuring the requirement of low latency of an image frame rendering process.

FIG. 12 is a block diagram of an image frame display apparatus according to an example embodiment. As shown in FIG. 12, the apparatus is configured to execute all or some of steps of the method shown in the corresponding embodiments shown in FIG. 3 or FIG. 4. The image frame display apparatus may include:
an instruction transmission module 1210, configured to transmit a first rendering instruction to a terminal, the first rendering instruction being used for instructing to render at least one first image element;
a second rendering module 1220, configured to call a second rendering instruction to render at least one second image element;
a data transmission module 1230, configured to transmit image data including the second image element to the terminal; and
an interactive transmission module 1240, configured to transmit an interactive instruction to the terminal, so as to cause the terminal to display an image frame based on the at least one first image element, the at least one second image element, and the interactive instruction, the interactive instruction being used for indicating a display mode of the at least one first image element and the at least one second image element.

In a possible implementation, the instruction transmission module 1210 includes:

an instruction transmission submodule, configured to transmit, to the terminal by a remote procedure call (RPC), a rendering function name corresponding to the first rendering instruction and related parameters used during rendering the at least one first image element.

In a possible implementation, the apparatus further includes:
a first element determining module, configured to, before the first rendering instruction is transmitted to the terminal, determine a to-be-rendered image element as the first image element in response to a specified parameter of the to-be-rendered image element satisfying a terminal rendering condition; and
a second element determining module, configured to determine the to-be-rendered image element as the second image element in response to the specified parameter of the to-be-rendered image element not satisfying the terminal rendering condition,
where the specified parameter includes at least one of image complexity and a display quality requirement.

To sum up, in a solution shown in this embodiment of this application, after receiving a first rendered element rendered by a terminal and a second rendered element rendered by a server, the terminal receives an interactive instruction that is used for determining a display mode of a first image element and a second image element and transmitted by the server, to enable the terminal to display the first image element and the second image element on an image frame through the display mode indicated by the interactive instruction, such that the process of rendering some of image elements is transferred to the terminal, and image elements respectively rendered by the terminal and the server can be displayed in a synthesized manner, thereby improving the quality of rendering some of the image elements while ensuring the requirement of low latency of an image frame rendering process.

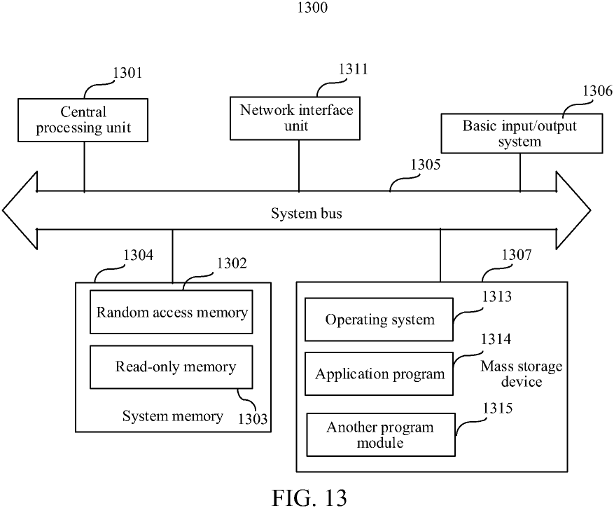

FIG. 13 is a schematic structural diagram of a computer device according to an example embodiment. The computer device 1300 includes a central processing unit (CPU) 1301, a system memory 1304 including a random access memory (RAM) 1302 and a read-only memory (ROM) 1303, and a system bus 1305 connecting the system memory 1304 and the central processing unit 1301. The computer device 1300 further includes a basic input/output system 1306 assisting in transmitting information between components in the computer, and a mass storage device 1307 configured to store an operating system 1313, an application program 1314, and another program module 1315.

The mass storage device 1307 is connected to the central processing unit 1301 by a mass storage controller (not shown) connected to the system bus 1305. The mass storage device 1307 and a computer-readable medium associated with the large-capacity storage device provide non-volatile storage to the computer device 1300. That is, the mass storage device 1307 may include a computer-readable medium (not shown) such as a hard disk or a compact disc read-only memory (CD-ROM) drive.

In general, the computer-readable medium may include a computer storage medium and a communication medium. The computer storage medium includes volatile and non-volatile media, and removable and non-removable media implemented by using any method or technology used for storing information such as computer-readable instructions, data structures, program modules, or other data. The computer storage medium includes a RAM, a ROM, a flash memory or another solid-state storage technology, a CD-ROM, or another optical storage, a magnetic cassette, a magnetic tape, or a magnetic disk storage or another magnetic storage device. Certainly, a person skilled in the art can learn that the computer storage medium is not limited to the foregoing a plurality of types. The system memory 1304 and the mass storage device 1307 may be collectively referred to as a memory.

The computer device 1300 may be connected to the Internet or another network device by a network interface unit 1311 connected to the system bus 1305.

The memory further includes one or more programs. The one or more programs are stored in the memory. The central processing unit 1301 executes the one or more programs to implement all or some of steps of the method shown in FIG. 2 or FIG. 4.

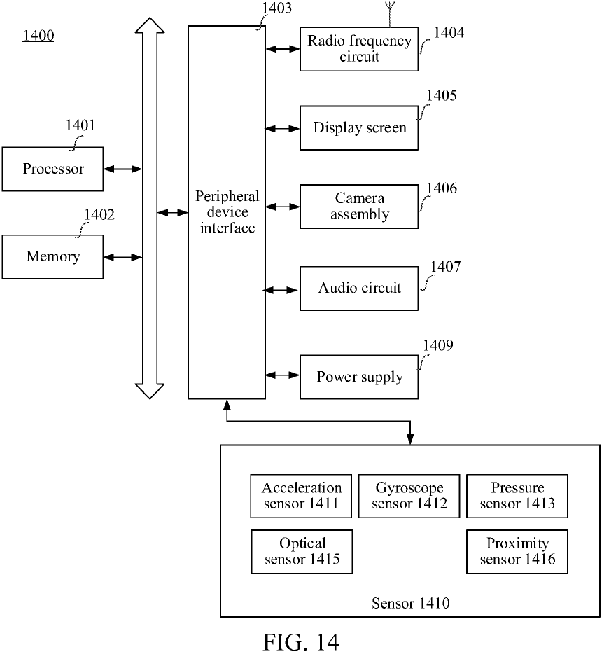

FIG. 14 is a schematic structural diagram of a computer device 1400 according to an example embodiment. The computer device 1400 may be a user terminal, such as a smartphone, a tablet computer, a moving picture experts group audio layer III (MP3) player, a moving picture experts group audio layer IV (MP4) player, a notebook computer, or a desktop computer. The computer device 1400 may also be referred to as another name such as user equipment, a portable terminal, a laptop terminal, or a desktop terminal.

Generally, the computer device 1400 includes: a processor 1401 and a memory 1402.

The processor 1401 may include one or more processing cores, for example, a quad-core processor or an octa-core processor. The processor 1401 may also include a primary processor and a coprocessor. The primary processor is a processor configured to process data in an awake state, and is also referred to as a central processing unit (CPU); and the coprocessor is a low-power processor configured to process data in a standby state. In some embodiments, the processor 1401 may be integrated with a graphics processing unit (GPU). The GPU is configured to render and draw content to be displayed on a display screen.

In some embodiments, the computer device 1400 may also include: a peripheral device interface 1403 and at least one peripheral device. Specifically, the peripheral device includes: at least one of a radio frequency circuit 1404, a display screen 1405, a camera assembly 1406, an audio circuit 1407, and a power supply 1409.

The display screen 1405 is configured to display a user interface (UI). The UI may include a graphic, text, an icon, a video, and any combination thereof.

In some embodiments, the computer device 1400 further includes one or more sensors 1410. The one or more sensors 1410 include, but are not limited to: an acceleration sensor 1411, a gyroscope sensor 1412, a pressure sensor 1413, an optical sensor 1415, and a proximity sensor 1416.

A person skilled in the art can understand that the structure shown in FIG. 14 constitutes no limitation on the computer device 1400, which may include more or fewer components than those shown in the figure, or some components may be combined, or a different component deployment may be used.

In an example embodiment, also provided is a non-transitory computer-readable storage medium including instructions. For example, a memory including at least one instruction, at least one program, a code set, or an instruction set. The at least one instruction, the at least one program, the code set, or the instruction set may be executed by a processor to accomplish all or some of steps of the method shown in the corresponding embodiments of FIG. 3 or FIG. 4. For example, the non-transitory computer-readable storage medium may be a read-only memory (ROM), a random access memory (RAM), a compact disc read-only memory (CD-ROM), a magnetic tape, a floppy disk, an optical data storage device, or the like.

According to an aspect of this application, provided is a computer program product or a computer program, where the computer program product or the computer program includes a computer instruction, and the computer instruction is stored in a computer-readable storage medium. A processor of a terminal reads the computer instruction from the computer-readable storage medium, and the processor executes the computer instruction to cause the terminal to execute the image frame display method provided in various implementations according to the foregoing aspects.

After considering the specification and practicing the present disclosure, a person skilled in the art can easily conceive of other implementations of this application. This application is intended to cover any variations, uses, or adaptive changes of this application. These variations, uses, or adaptive changes follow the general principles of this application and include common general knowledge or common technical means in the art, which are not disclosed in this application. The specification and the embodiments are considered as merely examples, and the scope and spirit of this application are pointed out in the following claims.

In this application, the term “unit” or “module” in this application refers to a computer program or part of the computer program that has a predefined function and works together with other related parts to achieve a predefined goal and may be all or partially implemented by using software, hardware (e.g., processing circuitry and/or memory configured to perform the predefined functions), or a combination thereof. Each unit or module can be implemented using one or more processors (or processors and memory). Likewise, a processor (or processors and memory) can be used to implement one or more modules or units. Moreover, each module or unit can be part of an overall module that includes the functionalities of the module or unit. It is to be understood that this application is not limited to the precise structures described above and shown in the accompanying drawings, and various modifications and changes can be made without departing from the scope of this application. The scope of this application is subject only to the appended claims.

What is claimed is:

1. An image frame display method performed by a computer device and the method comprising:
receiving a first rendering instruction transmitted by a server;
rendering at least one first image element based on the first rendering instruction;
receiving at least one second image element transmitted by the server, the at least one second image element being rendered by the server; and
displaying an image frame based on the at least one first image element and the at least one second image element.

2. The method according to claim 1, further comprising:
obtaining an interactive instruction indicating a display mode of the at least one first image element and the at least one second image element; and
combining the at least one first image element and the at least one second image element in accordance with the interactive instruction to form the image frame.

3. The method according to claim 1, wherein the receiving an interactive instruction transmitted by the server comprises:
receiving, from the server, a first interactive instruction that corresponds to the first image element; and
receiving, from the sever, a second interactive instruction that corresponds to the second image element.

4. The method according to claim 3, wherein the displaying an image frame based on the at least one first image element, the at least one second image element, and the interactive instruction comprises:
determining a display mode of the first image element and the second image element based on the first interactive instruction and the second interactive instruction; and
displaying the at least one first image element and the at least one second image element according to the display mode of the first image element and the second image element.

5. The method according to claim 4, wherein, the display mode is synchronous display, the first interactive instruction comprises a first interaction parameter, the second interactive instruction comprises a second interaction parameter, and the first interaction parameter and the second interaction parameter comprise synchronization time indication information of the first image element and the second image element, respectively; and
the displaying the at least one first image element and the at least one second image element according to the display mode of the first image element and the second image element comprises:
synchronously displaying image elements among the at least one first image element and the at least one second image element that match the synchronization time indication information.

6. The method according to claim 4, wherein, the display mode is transparency synthesis display, the first interactive instruction comprises a first interaction parameter, the second interactive instruction comprises a second interaction parameter, and the first interaction parameter and the second interaction parameter comprise transparency information of the first image element and the second image element, respectively; and
the displaying the at least one first image element and the at least one second image element according to the display mode of the first image element and the second image element comprises:
determining transparency of the at least one first image element and the at least one second image element based on the transparency information of the at least one first image element and the at least one second image element; and
performing transparency synthesis display on the at least one first image element and the at least one second image element based on the transparency of the at least one first image element and the at least one second image element.

7. The method according to claim 4, wherein, the display mode is separate display, the displaying the at least one first image element and the at least one second image element according to the display mode of the first image element and the second image element comprises:
separately displaying the at least one first image element and the at least one second image element.

8. The method according to claim 1, wherein the rendering the at least one first image element based on the first rendering instruction comprises:
obtaining a rendering function name comprised in the first rendering instruction, and related parameters used during rendering the at least one first image element; and
calling, based on the rendering function name, a function interface corresponding to the rendering function name, so as to render the at least one first image element through the function interface and the related parameters.

9. The method according to claim 1, wherein, the image frame is a virtual scene picture, the first image element comprises at least one of an icon, a graphic button of a virtual control, and a graphic comprising text content, superimposed on the virtual scene picture; and the second image element comprises an image used for displaying the virtual scene in the virtual scene picture.

10. A computer device, comprising a processor and a memory, the memory storing at least one computer instruction, and the at least one computer instruction, when executed by the processor, causing the computer device to implement an image frame display method including:
receiving a first rendering instruction transmitted by a server;
rendering at least one first image element based on the first rendering instruction;
receiving at least one second image element transmitted by the server, the at least one second image element being rendered by the server; and
displaying an image frame based on the at least one first image element and the at least one second image element.

11. The computer device according to claim 10, wherein the method further comprises:
obtaining an interactive instruction indicating a display mode of the at least one first image element and the at least one second image element; and
combining the at least one first image element and the at least one second image element in accordance with the interactive instruction to form the image frame.

12. The computer device according to claim 10, wherein the receiving an interactive instruction transmitted by the server comprises:
receiving, from the server, a first interactive instruction that corresponds to the first image element; and
receiving, from the sever, a second interactive instruction that corresponds to the second image element.

13. The computer device according to claim 11, wherein the displaying an image frame based on the at least one first image element, the at least one second image element, and the interactive instruction comprises:
determining a display mode of the first image element and the second image element based on the first interactive instruction and the second interactive instruction; and
displaying the at least one first image element and the at least one second image element according to the display mode of the first image element and the second image element.

14. The computer device according to claim 12, wherein, the display mode is synchronous display, the first interactive instruction comprises a first interaction parameter, the second interactive instruction comprises a second interaction parameter, and the first interaction parameter and the second interaction parameter comprise synchronization time indication information of the first image element and the second image element, respectively; and
the displaying the at least one first image element and the at least one second image element according to the display mode of the first image element and the second image element comprises:
synchronously displaying image elements among the at least one first image element and the at least one second image element that match the synchronization time indication information.

15. The computer device according to claim 12, wherein, the display mode is transparency synthesis display, the first interactive instruction comprises a first interaction parameter, the second interactive instruction comprises a second interaction parameter, and the first interaction parameter and the second interaction parameter comprise transparency information of the first image element and the second image element, respectively; and
the displaying the at least one first image element and the at least one second image element according to the display mode of the first image element and the second image element comprises:
determining transparency of the at least one first image element and the at least one second image element based on the transparency information of the at least one first image element and the at least one second image element; and
performing transparency synthesis display on the at least one first image element and the at least one second image element based on the transparency of the at least one first image element and the at least one second image element.

16. The computer device according to claim 12, wherein, the display mode is separate display, the displaying the at least one first image element and the at least one second image element according to the display mode of the first image element and the second image element comprises:
separately displaying the at least one first image element and the at least one second image element, so as to display the image frame.

17. The computer device according to claim 10, wherein the rendering the at least one first image element based on the first rendering instruction comprises:
obtaining a rendering function name comprised in the first rendering instruction, and related parameters used during rendering the at least one first image element; and
calling, based on the rendering function name, a function interface corresponding to the rendering function name, so as to render the at least one first image element through the function interface and the related parameters.

18. The computer device according to claim 10, wherein, the image frame is a virtual scene picture, the first image element comprises at least one of an icon, a graphic button of a virtual control, and a graphic comprising text content, superimposed on the virtual scene picture; and the second image element comprises an image used for displaying the virtual scene in the virtual scene picture.

19. A non-transitory computer-readable storage medium, storing at least one computer program, the computer program, when executed by a processor of a computer device, causing the computer device to implement an image frame display method including:
receiving a first rendering instruction transmitted by a server;
rendering at least one first image element based on the first rendering instruction;
receiving at least one second image element transmitted by the server, the at least one second image element being rendered by the server;
receiving an interactive instruction transmitted by the server; and
displaying an image frame based on the at least one first image element, the at least one second image element, and the interactive instruction.

20. The non-transitory computer-readable storage medium according to claim 19, wherein the method further comprises:
obtaining an interactive instruction indicating a display mode of the at least one first image element and the at least one second image element; and
combining the at least one first image element and the at least one second image element in accordance with the interactive instruction to form the image frame.

21. The non-transitory computer-readable storage medium according to claim 19, wherein, the image frame is a virtual scene picture, the first image element comprises at least one of an icon, a graphic button of a virtual control, and a graphic comprising text content, superimposed on the virtual scene picture; and the second image element comprises an image used for displaying the virtual scene in the virtual scene picture.
